(19) United States
(12) Patent Application Publication
(10) Pub. No.: US 2020/0016778 A1
(43) Pub. Date: Jan. 16, 2020

(54) Cutting Tool With Soft Handles and Method of Making Same

(71) Applicant: Acme United Corporation, Fairfield, CT (US)

(72) Inventors: Sarah A. Albano, Fairfield, CT (US); Siu-Leung Tang, Hong Kong (CN)

(21) Appl. No.: 16/509,881

(22) Filed: Jul. 12, 2019

Related U.S. Application Data
(60) Provisional application No. 62/697,693, filed on Jul. 13, 2018.

(51) Int. Cl. B26B 13/20; B25G 1/10; B26B 13/02; B29C 45/14; B29C 45/16

(52) U.S. Cl. CPC B26B 13/20; B25G 1/102; B29K 2101/12; B29C 45/14426; B29C 45/1676; B26B 13/02

(57) ABSTRACT

A dual blade cutting tool is disclosed herein that comprises first and second cutting blades, a finger handle formed on the first cutting blade, the finger handle comprising a first core and a first exoskeleton formed over the first core, a thumb handle formed on the second cutting blade, the thumb handle comprising a second core and a second exoskeleton formed over the second core. The first and second cores have a combination of thickness and rigidity to render the cutting tool suitable for use in cutting, and the first and second exoskeletons have a combination of thickness and softness to provide comfort during extended use of the cutting tool. A method of making the cutting tool also is disclosed.

### BACKGROUND

Scissors having handles made of thermoplastic and/or thermoset materials are generally known. In many cases, the handles are made of hard plastic that tends to further harden with time. The scissors can become uncomfortable for a user when used continuously over an extended period of time.

It would be useful to develop durable scissors having a handle with improved comfort.

### SUMMARY

One embodiment described herein is a dual blade cutting tool comprising first and second cutting blades, a finger handle formed on the first cutting blade, the finger handle comprising a first core and a first exoskeleton formed over the first core, and a thumb handle formed on the second cutting blade, the thumb handle comprising a second core and a second exoskeleton formed over the second core. The first and second cores have a combination of thickness and rigidity to render the cutting tool suitable for use in cutting, and the first and second exoskeletons have a combination of thickness and softness to provide comfort during extended use of the cutting tool.

Another embodiment described herein is a method of making a pair of scissors, comprising obtaining a first cutting blade having a cutting end portion and a support end portion, molding a first rigid handle over the support end portion of the first cutting blade, and molding a first soft exoskeleton over at least a portion of the first rigid handle, forming a first scissor component. The method further comprises obtaining a second cutting blade having a cutting end portion and a support end portion, molding a second rigid handle over the support end portion of the second cutting blade, molding a second soft exoskeleton over at least a portion of the second rigid handle, forming a second scissor component, and pivotally connecting the first and second scissor components to one another.

### BRIEF DESCRIPTION OF THE DRAWINGS

FIG. 1 shows a perspective view from a front side of a first embodiment described herein.

FIG. 2 shows a perspective view of the embodiment of FIG. 1 from a back side.

FIG. 3 is a partially exploded view of the embodiment shown in FIG. 1.

FIG. 4 is a photo of the finger handle with the second shell removed.

FIG. 5 is a photo of the thumb handle with the fourth shell removed.

FIG. 6 is a sectional view of a second embodiment showing the thicknesses of the inner and outer layers of the handles.

FIG. 7 shows a perspective view from a front side of the second embodiment described herein.

FIG. 8 shows a perspective view of the embodiment of FIG. 7 from a back side.

FIG. 9 is a partially exploded view of the embodiment shown in FIG. 7.

FIG. 10 is a sectional view of a third embodiment showing the relative thicknesses of the inner and outer layers of the handles.

FIG. 11 is a sectional view of a fourth embodiment showing the relative thicknesses of the inner and outer layers of the handles.

FIG. 12 is a section view of a fifth embodiment with ribbed handles showing the relative thicknesses of the inner and outer layers of the handles.

### DETAILED DESCRIPTION

The scissors described herein provide the user's hand with comfort during cutting by using a soft handle. The scissors also are constructed to be internally rigid and durable to allow for precise cutting over a long useful life.

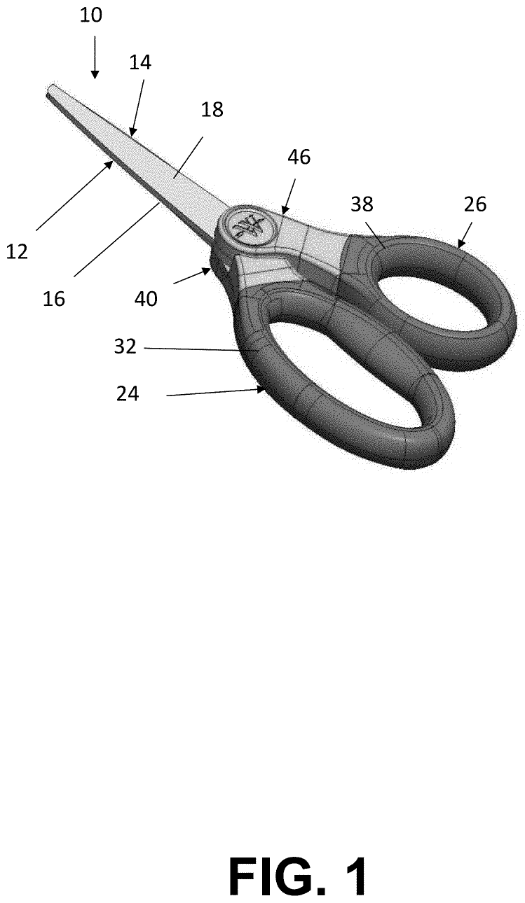

Referring to the drawings, FIG. 1 shows a first embodiment of a pair of scissors, general designated as 10. The scissors 10 include a first scissor component 12 and a second scissor component 14. The first scissor component 12 includes a first blade 16 and a finger handle 24 attached thereto, configured to receive the user's fingers. The second scissor component 14 includes a second blade 18 and a thumb handle 26 attached thereto, configured to receive the user's thumb.

Each handle 24, 26 has a rigid inner layer to impart durability and cutting precision, and a soft outer layer to promote comfort to the user, especially when the scissors are used continuously over an extended period of time. More specifically, the finger handle 24 includes a substantially rigid inner first core 30 having a soft first exoskeleton 32 formed thereon. The thumb handle 26 includes a substantially rigid inner second core 36 having a soft second exoskeleton 38 formed thereon. In embodiments, the exoskeletons are molded directly over the inner cores.

To reinforce the connection between a core, an exoskeleton and a corresponding blade, covers 40, 46 are placed over these connections. More specifically, a finger handle cover 40 is mounted over the portion of the first scissor component 12 which is connected to the first blade 16. The finger handle cover 40 includes a first shell 42 and a second shell 44. The first shell 42 includes an outer flat surface 45 and an inner flat surface 43 with a first aperture 49 formed therein that is configured to receive a screw 60 that holds the two blades together. The first blade 16 has a bore 65 that is aligned with the first aperture 49. The first shell 42 also includes a tubular first projection 47 configured to receive a second projection 53 formed on the inner surface of the second shell 44. The second projection 53 extends through a second aperture in the first blade 16 and the first handle 24. The second projection 53 can be fixed in the first tubular projection 47 in a suitable manner, such as using an adhesive, a snap fit, melt or pressure fusing, or another suitable attachment mechanism.

A thumb handle cover 46 is mounted over the portion of the second scissor component 14 which is connected to the second blade 18. The thumb handle cover 46 includes a third shell 48 and a fourth shell 50. The third shell 48 includes an outer flat surface 52 and an inner flat surface 56 with a third tubular, screw-supporting projection 59 formed thereon extending generally perpendicularly from the inner surface 56 of the third shell 48. The third shell 48 also has, on its inner surface 56, a fourth tubular projection 63 configured to receive a fifth projection 55 extending generally perpendicularly from the inner surface 54 of the fourth shell 50. The fifth projection 55 can be fixed in the fourth tubular projection 63 in a suitable manner, such as using an adhesive, a snap fit, melt or pressure fusing, or another suitable attachment mechanism.

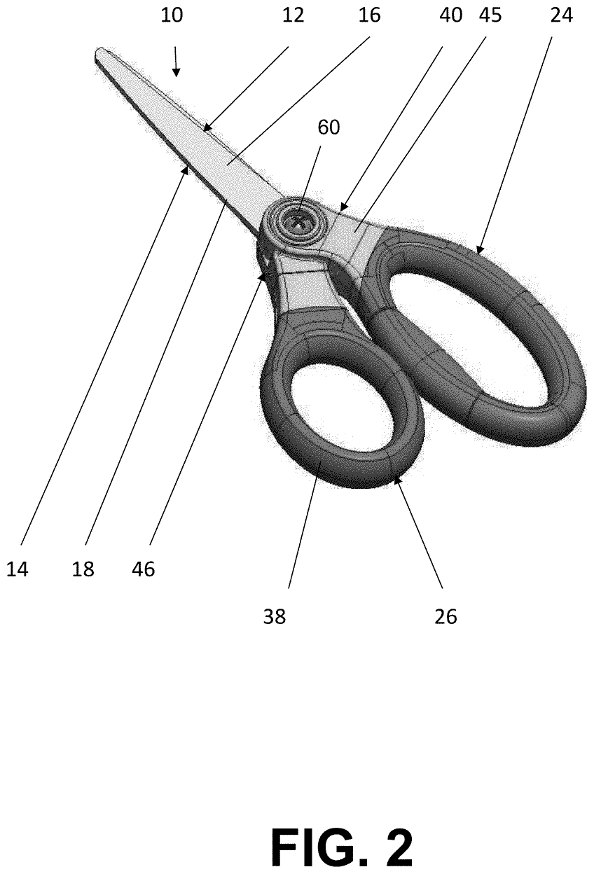

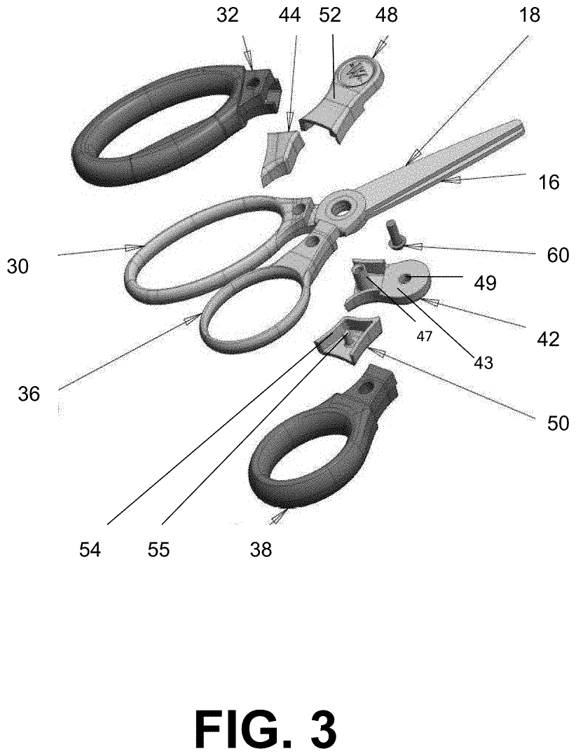

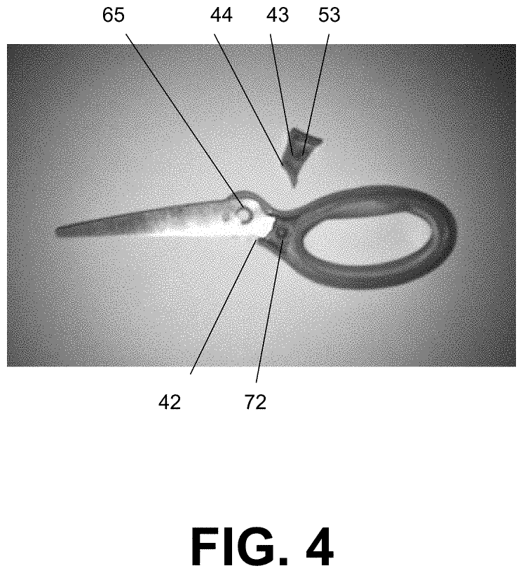

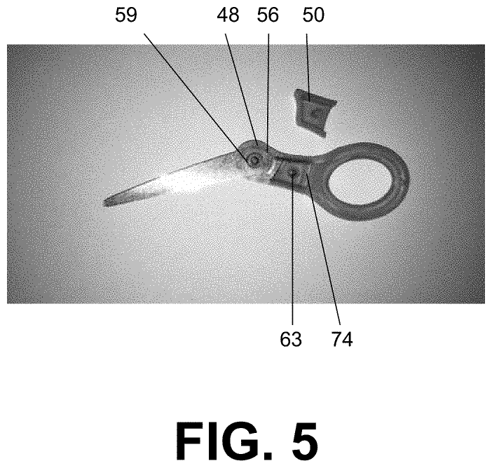

In some embodiments, including the embodiments shown in FIGS. 1-6, a thin layer 72 of the first exoskeleton 32 and a thin layer 74 of the second exoskeleton 36 are disposed under the covers 40, 46.

The first and second scissor components 12, 14 are pivotally connected by a connector 60, such as a screw or bolt. In the embodiments shown in FIGS. 1-7, the tubular projection 59 is internally threaded to receive a screw 60.

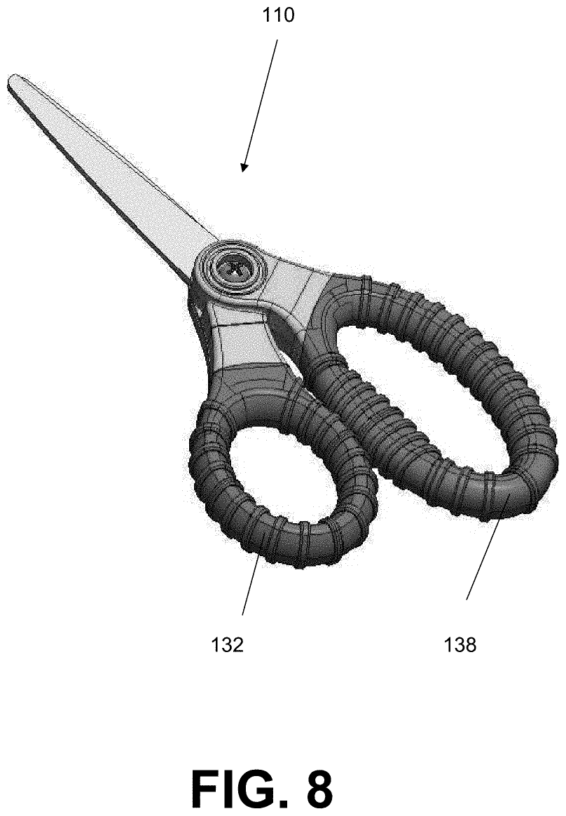

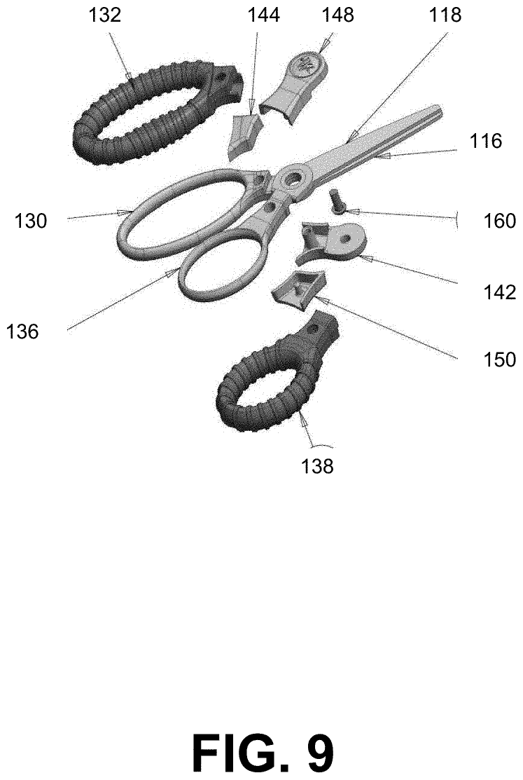

In the embodiments shown in FIGS. 1-9, the core 30 of the finger handle has a cross sectional length of about 2-4.5 mm, or about 3-4 mm, and a cross sectional width Wf of about 2-4 mm, or about 3-3.8 mm. The core 36 of the thumb handle has a cross sectional length of about 2-4.5 mm, or about 3-4 mm, and a cross sectional width of about 2-4 mm, or about 3-3.8 mm. In embodiments, the core thickness varies within the range of about 2.5 mm to about 4 mm.

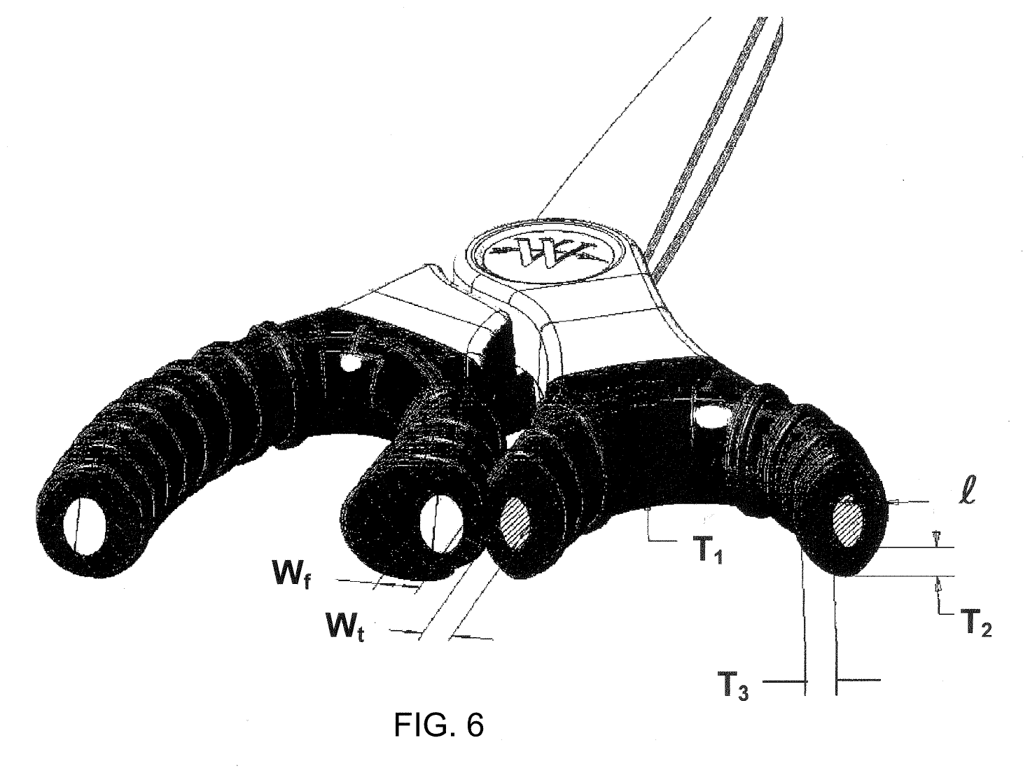

The thickness of the exoskeleton varies between about 1 mm and about 5 mm, or about 1-3 mm. In the embodiment shown in FIG. 6, the thickest part of the exoskeleton is on the interior portion of the finger handle 24 where the padded side of a user's fingers touch the finger handle 24, and can be about 3-5 mm. The thinnest part of the exoskeleton is on the outer portion of the thumb handle, which is not in contact with the user's hand during use of the scissors. In embodiments, the thickness of the exoskeleton varies within the range of about 1.5 mm to about 3 mm.

In order to make the scissors, the rigid handle cores are mounted on the blades, and the soft exoskeletons are then formed over the portion of the cores that comes into contact with the user's hands. The handle covers are mounted in pairs to opposite sides of the scissor components, blades are connected with the connector 60.

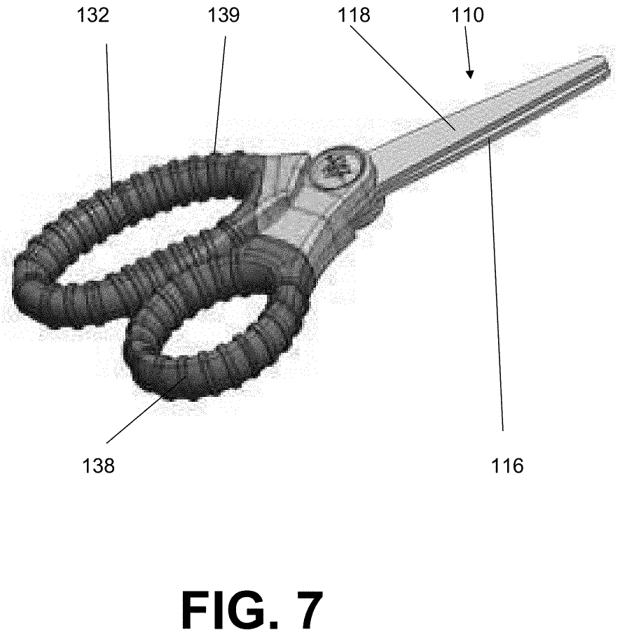

FIGS. 7-9 show a second embodiment of scissors 110 in which the exoskeletons 132, 138 have rows of parallel ribs 139 extending outwardly to improve grippability of the handles. The scissors 110 include blades 116 and 118. The overall construction of the scissors 110 is similar to the first embodiment in that they include a substantially rigid inner first core 130, a substantially rigid inner second core 136, a finger handle cover formed from a first shell 142 and a second shell 144, as well as a thumb handle cover former from a third shell 148 and a fourth shell 150. The scissor components are held together by a screw 160.

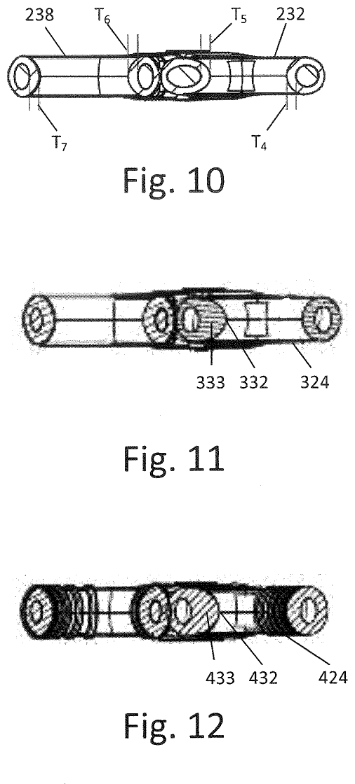

FIGS. 10 is a sectional view of a third embodiment showing the relative thicknesses of the inner and outer layers of the handles. FIG. 11 is a sectional view of a fourth embodiment showing the relative thicknesses of the inner and outer layers of the handles. FIG. 12 is a sectional view of a fifth embodiment with ribbed handles showing the relative thicknesses of the inner and outer layers of the handles. In each of these embodiments, the thickness of the exoskeleton varies between about 1 mm and about 5 mm, or about 1-4 mm. In the embodiment shown in FIG. 10, the first exoskeleton 232 (of the finger portion) and the second exoskeleton 238 (of the thumb portion) each have a generally uniform thickness T₄, T₅, T₆ and T₇, of about 2.4 mm to about 3.2 mm. In the embodiment shown in FIG. 11, the thickest part of the first exoskeleton 332 is on the interior portion 333 of the finger handle 324. In the embodiment shown in FIG. 12, the thickest part of the first exoskeleton 432 is on the interior portion 433 of the finger handle 424.

In embodiments, both the cores and the exoskeletons comprise thermoplastic material, and the melting point of the material used to form the cores is lower than the melting point of the material used to form the exoskeletons. In other embodiments, both the cores and the exoskeletons comprise thermoplastic material, and the melting point of the material used to form the cores is higher than the melting point of the material used to form the exoskeletons. In some cases, the cores comprise a thermoset material and the exoskeletons comprise a thermoplastic material. In other embodiments, both the cores and the exoskeletons comprise thermoset materials.

Non-limiting examples of rigid materials for use in making the handle cores include polybutadiene, polyvinyl chloride, polyurethane, polyimide, polyimide, polyolefins such as polyethylene and polypropylene, polyester and polystyrene, as well as copolymers and terpolymers of these materials. In embodiments, the cores comprise acrylonitrile butadiene styrene (ABS).

Non-limiting examples of soft materials for use in making the handle exoskeletons include polyesters, polyolefins, styrene block copolymers, polyurethanes, polyamides. In embodiments, a thermoplastic elastomer containing a polyolefin and styrene is used.

In embodiments, the cores comprise a hard material with a Rockwell Hardness in the range of about 95-122 (ASTM-D785), or about 110 to about 120. In embodiments, the exoskeletons comprise a soft material with a Shore A hardness in the range of about 13 to about 20, or about 14 to about 18.

A number of alternatives, modifications, variations, or improvements therein may be subsequently made by those skilled in the art, which are also intended to be encompassed by the following claims.

What is claimed is:

1. A dual blade cutting tool comprising:
first and second cutting blades,
a finger handle formed on the first cutting blade, the finger handle comprising a first core and a first exoskeleton formed over the first core,
a thumb handle formed on the second cutting blade, the thumb handle comprising a second core and a second exoskeleton formed over the second core,
the first and second cores having a combination of thickness and rigidity to render the cutting tool suitable for use in cutting, and
the first and second exoskeletons having a combination of thickness and softness to provide comfort during extended use of the cutting tool.

2. The cutting tool of claim 1, wherein the first and second cores have a Rockwell Hardness in the range of about 95 to about 122.

3. The cutting tool of claim 1, wherein the first and second exoskeletons have a Shore A hardness in the range of about 13 to about 20.

4. The cutting tool of claim 1, further comprising a connector pivotally connecting the first and second blades.

5. The cutting tool of claim 4, further comprising a finger handle cover mounted over the connector.

6. The cutting tool of claim 5, wherein the finger handle cover comprises first and second shells mounted to opposite sides of the first cutting blade and the first exoskeleton.

7. The cutting tool of claim 5, further comprising a thumb handle cover mounted over the connector opposite of the finger handle cover.

8. The cutting tool of claim 7, wherein the thumb handle cover comprises third and fourth shells mounted to opposite sides of the second cutting blade and the second exoskeleton.

9. The cutting tool of claim 1, wherein the first core and the second core comprise a thermoset material.

10. The cutting tool of claim 9, wherein the first core and the second core comprise at least one member selected from the group consisting of thermoplastic polymers and thermosetting polymers.

11. The cutting tool of claim 9, wherein the first exoskeleton and the second exoskeleton comprise at least one member selected from the group consisting of thermoplastic polymers and thermosetting polymers.

12. The cutting tool of claim 10, wherein the first and second cores comprise butadiene.

13. The cutting tool of claim 11, wherein the first and second cores comprise a thermoplastic elastomer.

14. The cutting tool of claim 1, wherein the first and second cores have thicknesses in the range of about 2.5 mm to about 4 mm.

15. The cutting tool of claim 1, wherein the first and second exoskeletons have thicknesses in the range of about 1.5 mm to about 3 mm.

16. The cutting tool of claim 1, wherein the tool comprises scissors.

17. A method of making a pair of scissors, comprising:
obtaining a first cutting blade having a cutting end portion and a support end portion,
molding a first rigid handle over the support end portion of the first cutting blade,
molding a first soft exoskeleton over at least a portion of the first rigid handle, forming a first scissor component,
obtaining a second cutting blade having a cutting end portion and a support end portion,
molding a second rigid handle over the support end portion of the second cutting blade,
molding a second soft exoskeleton over at least a portion of the second rigid handle, forming a second scissor component, and
pivotally connecting the first and second scissor components to one another.

18. The method of claim 17, further comprising, before or after pivotally connecting the first and second scissor components,
forming a first cover over a portion of the first soft exoskeleton and the adjacent portion of the first rigid handle, and
forming a second cover over a portion of the second soft exoskeleton and the adjacent portion of the second rigid handle.

19. The method of claim 17, wherein each of the first and second covers comprises opposite first and second segments.
